(19) United States
(12) Patent Application Publication
(10) Pub. No.: US 2021/0166403 A1
(43) Pub. Date: Jun. 3, 2021

(54) CLASSIFICATION OF PIXEL WITHIN IMAGES CAPTURED FROM THE SKY

(71) Applicant: Siemens Aktiengesellschaft, Muenchen (DE)

(72) Inventors: Ti-chiun Chang, Princeton Junction, NJ (US); Patrick Reeb, Adelsdorf (DE); Andrei Szabo, Ottobrunn (DE); Joachim Bamberger, Stockdorf (DE)

(21) Appl. No.: 17/251,910

(22) PCT Filed: Jun. 14, 2018
(86) PCT No.: PCT/EP2018/065782

§ 371 Date: Dec. 14, 2020

(51) Int. Cl. G06T 7/215; G06K 9/00; G06K 9/62

(52) U.S. Cl. CPC G06T 7/215; G06K 9/0063; G06T 2207/20224; G06K 9/6226; G06K 9/629

(57) ABSTRACT

Pixels are classified within a time series of first and second images for the first image, a first probability map is provided with a first probability for a cloud for each first pixel and, for the second image, a second probability map with a second probability for a cloud for each second pixel; first and second mean intensity values are calculated for the pixels; local zero mean images are calculated by subtracting the mean intensity value from the intensity value of the respective pixel; a maximum difference map is generated by calculating, for spatially corresponding pixels, an absolute difference value between a first and second zero mean value; a weighting map is produced by multiplying each absolute difference value with a non-linear function; and a classifying map is computed based on the first probability map, the second probability map, and the weighting map.

### FIELD OF INVENTION

The present invention generally relates to the technical field of photovoltaic power generation, wherein cloud dynamics within a local area of a photovoltaic power plant are predicted. In particular, the present invention relates to a method for classifying pixel within a time series of at least a previously captured first image and a currently captured second image of the sky. Further, the present invention relates to a data processing unit and to a computer program for carrying and/or controlling the method. Furthermore, the present invention relates to an electric power system with such a data processing unit.

### Art Background

In many geographic regions photovoltaic power plants are an important energy source for supplying renewal energy or power into a power network or utility grid. By nature, the power production of a photovoltaic power plant depends on the time varying intensity of sun light which is captured by the photovoltaic cells of the photovoltaic power plant. While the dependency of the sun light intensity as a function of the time of the day and the day of the year is known (depending on the geographic location of the photovoltaic power plant), other factures having an influence on the light intensity, which can be captured, have to predicted in order to inform an operator of the respective power network about the amount of power which can be supplied in the (near) future to the power network. This information is essential in order to provide for an appropriate control of (i) other power plants supplying electric power to the power network and/or (ii) electric consumers which withdraw electric power from the power network.

Cloud coverage of the sun light is a factor which may strongly reduce the sun light intensity and which, as a consequence, has a strong impact on the stability and/or on the efficiency of a photovoltaic power plant. Unfortunately, cloud dynamics within a local area of a photovoltaic power plant and within a short time horizon such as e.g. about 20 minutes cannot be accurately predicted by known computational models.

Generally, a camera based system installed in the vicinity of a photovoltaic power plant can be used for a cloud coverage prediction. Such a system captures images of the sky continuously over periodic intervals, for example, every few seconds. By means of an analysis of a time series of captured images a reasonable estimate of cloud trajectories may be obtained. Predictions of when and how much sunlight will be occluded in the near future may be made through the analysis.

Such an analysis may employ a so called cloud segmentation allowing to identify pixels of the captured images as to be a “cloud pixel”. However, due to variations in sky conditions, different time of the day and time of the year, etc., accurately identifying clouds in captured images is very challenging. A difficult but important region within a captured image is the region near the sun, where intensity saturation and optical artifacts such as glares are present. A cloud segmentation classifier working well for image regions spaced apart from the sun may not work well for the near sun region. Specifically, glares are often mistakenly identified as clouds while most of the sky is clear. For instance, already within a series of two consecutive sky images a cloud segmentation classifier could mistakenly detect a cloud in the second image due to an unperceivable color change.

There may be a need for improving the reliability of a cloud segmentation in order to improve in particular short term prediction for cloud coverage.

### SUMMARY OF THE INVENTION

This need may be met by the subject matter according to the independent claims. Advantageous embodiments of the present invention are described by the dependent claims.

According to a first aspect of the invention there is provided a method for classifying pixel within a time series of at least a previously captured first image and a currently captured second image of the sky, wherein each image comprises a plurality of pixels each having a certain intensity value. The provided method comprises (a) providing, for the first image, a first probability map comprising, for each pixel, a first probability value that the pixel represents a cloud (portion) in the sky and providing, for the second image, a second probability map comprising, for each pixel, a second probability value that the pixel represents a cloud (portion) in the sky; (b) calculating a first mean intensity value for first pixels of the first image and calculating a second mean intensity value for second pixels of the second image; (c) determining a first local zero mean image by subtracting, for each first pixel, the first mean intensity value from the intensity value of the respective first pixel and determining a second local zero mean image by subtracting, for each second pixel, the second mean intensity value from the intensity value of the respective second pixel; (d) generating a maximum difference map by calculating, for each first pixel and for a spatially corresponding second pixel, an absolute difference value between a respective first zero mean value of the first local zero mean image and a respective second zero mean value of the second local zero mean image; (e) producing a weighing map by multiplying each absolute difference value of the maximum difference map with a function value of a non-linear function specifying the function value as a non-linear function of the absolute difference value; and (f) computing a pixel classifying map based on the first probability map, the second probability map, and the weighing map.

The described method is based on the idea that by calculating a weighing map which has been generated inter alia with a non-linear function and by using this weighing map for weighing two known probability maps a modified pixel classifying map can be computed which has an improved pixel classification validity. Thereby, the classification of the pixels is indicative whether the respective pixel (i) is assigned to or represents (i) a portion of a cloud in the sky or (ii) a portion of the open sky.

The known probability maps may be generated by means of well-known image classifications procedures for segmentation of cloud/sky images. For the sake of conciseness of this disclosure, such procedures are not elucidated in detail in this document. In this respect reference is made solely and by example to the publication S. Dev, Y. H. Lee, S. Winkler, “Color-based Segmentation of Sky/Cloud Images From Ground-based Cameras”, IEEE J. of Selected Topics in Applied Earth Observations and Remote Sensing, Vol. 10, No. 1, January 2017, pp 231-242 and to the publication A. Heinle, A. Macke, and A. Srivastav, “Automatic Cloud Classification of Whole Sky Images”, Atmos. Meas. Tech., Vol. 3, May, 2010, pp 557-567.

With the described method the classification validity of cloud/sky images can be improved not only in image regions which are spatially distinct from the (current position of) sun. With the described method the classification validity can be significantly improved also within image regions which are close to the sun and which naturally suffer from glare effects causing a distortion with respect to the intensity values of the respective pixels.

It is pointed out that the described method as well as the generation of the known probability maps can be carried out repeatedly such that a movement, a change of size and/or shape, a change of the optical density an appearance, and/or a disappearance of clouds can be predicted in a particular reliable manner. This holds true in particular for a cloud prediction within a comparatively short time scale of e.g. 20 minutes.

In this document the term “intensity value” may refer to a digital number being indicative for the light energy which has been captured within a certain exposure time by the respective pixel (of a camera) capturing the cloud/sky image. In case the image is a black and white image the “intensity value” may be a so called grey scale value. In case of color picture the intensity value may be indicative simply for the intensity, i.e. captured energy per exposure time, of the captured light having a certain color.

Further, in this document the term “map” can be understood as a two dimensional matrix having a plurality of (intensity) values which are arranged in lines and in columns. The size of the matrix depends on the size and on the spatial resolution of the respective image.

Further, in this document the term “spatially corresponding pixels” may in particular refer to a pair of pixels which represent the same position or location of the sky. Thereby, a first one of the pixel pair is a pixel of the first image and the second one of the pixel pair is a pixel of the second image.

Further, in this document the term “absolute difference value” means the absolute, i.e. never negative, value of the difference between the intensity values of two spatially corresponding pixels each being assigned to one of the two images.

Generally and descriptively speaking, with the described method there is introduced an error mitigation for a so called perceptual structural difference algorithm in order to address a possibly incorrect cloud/sky segmentation caused by color appearance or contrast change between images of the sky. This is an independent perspective to a prediction of cloud occlusion based on the concept of optical flow wherein a cloud movement is determined by image processing of two subsequent images, which concept can be exploited by a machine learning method. Due to the independent perspective between (i) the described method, which can be seen as to represent a perceptual structural difference algorithm, and (ii) the optical flow concept, the described method will not make the same mistakes as a known cloud/sky segmentation algorithm. Therefore, the weakness of a conventional optical flow algorithm can be overcome by taking into account the perceptual aspect. The idea of the perceptual aspect is to look beyond pixel difference and come up with a measure that more faithfully reflects the human perception. As a result, the described method is capable to detect delicate cloud appearance differences between two images while being robust to background color or contrast changes.

According to an embodiment of the invention the first image is a first color image comprising, for each first pixel, at least three first spectral intensity values and the second image is a second color image comprising, for each second pixel, at least three second spectral intensity values. For determining the two local zero mean images (a) the first mean intensity value is given by the mean intensity of all first spectral intensity values; (b) the second mean intensity value is given by the mean intensity of all second spectral intensity values; (c) the first local zero mean image comprises at least three first spectral zero mean images each being determined by subtracting, for each first pixel, the first mean intensity value from the first spectral intensity value of the respective first pixel; and (d) the second local zero mean image comprises at least three second spectral zero mean images each being determined by subtracting, for each second pixel, the second mean intensity value from the second spectral intensity value of the respective second pixel. For generating the maximum difference map the absolute difference value is a maximum absolute difference value which is given by the biggest absolute difference of at least three spectral absolute difference values, wherein each one of the at least three spectral absolute difference values is calculated by, for each first pixel and for a spatially corresponding second pixel, the absolute difference value between one of the three first spectral intensity values and a spectrally corresponding one of the three second spectral intensity values.

In this context “spectrally corresponding” means that for calculating a spectral absolute difference value the second spectral intensity value is assigned to the same color as the first spectral intensity value.

Descriptively speaking, the step of calculating the two mean intensity values, the step of determining the two local zero mean images, and the step of generating the difference map are carried out separately for each color of the at least three colors of a color space, wherein with the step of generating the difference map the respective values being assigned two different colors are consolidated into the (only one) maximum difference map. This means that the step of producing the weighing map and the step of computing the pixel classifying map are “spectrally global” steps which are not carried out separately for different colors.

The described use of different spectral information and its consolidation into the maximum difference map may provide the advantage that (i) on the one hand spectral information is exploited in order to generally increase the reliability of the segmentation of cloud/sky images and (ii) on the other hand the probability of color artefacts will be significantly reduced, which may, in particular in pixel regions close to the sun, lead to unwanted artefacts which could reduce the classification validity of cloud/sky images.

The employed color space may be any color space which comprises at least three colors. Preferably, a typical space such as RGB, CIELAB or HSV (hue, saturation, value) is employed.

According to a further embodiment of the invention the method further comprises, after generating the maximum difference map and before producing the weighing map, modifying each absolute difference value by applying a threshold operation. The resulting modified absolute difference values are then used (as the absolute difference values) for producing the weighing map.

In this context it should be clear that with this threshold operation some modified absolute difference values may be different from the absolute difference values (if a threshold condition is met) and some modified absolute difference values may be the same as the absolute difference values (if a threshold condition is not met).

With the described threshold operation the (pixel) values of the maximum difference map are transformed into a further map which, in this document is denominated a “threshold map”. Thereby, the absolute difference values may become saturated, which may have a positive effect on noise such that the classification validity of cloud/sky images can be further improved.

According to a further embodiment of the invention applying the threshold operation comprises applying an upper threshold value, if the absolute difference value is larger than (or equal to) the upper threshold value and/or applying a lower threshold value, if the absolute difference value is smaller than (or equal to) the lower threshold value.

“Thresholding” the (modified) absolute difference value with an upper threshold value and/or with a lower threshold value is a simple but effective computational operation for noise reduction. In preferred embodiment the upper threshold value and/or the lower threshold value is the same for all pixels of the maximum difference map.

When applying the upper threshold value no larger values than the upper threshold value will be used. Therefore, the upper threshold value can be interpreted as to represent an upper limit or a maximum value. Correspondingly, when applying the lower threshold value no smaller values than the lower threshold value will be used. Therefore, the lower threshold value can be interpreted as to represent a lower limit or a minimum value.

According to a further embodiment of the invention the method further comprises, after modifying each absolute difference value by applying the threshold operation and before producing the weighing map, further modifying each (modified) absolute difference value by applying a normalization operation. The resulting further modified absolute difference values are then used (as the absolute difference values) for producing the weighing map.

Processing the data within a normalized range may provide the advantage that the calculations, which have to be performed when carrying out the described method, will become easier. Hence, the computational effort will be reduced, which may be in particular of importance when the described method is carried repeatedly with a high repetition rate in order to perform a segmentation of cloud/sky images very frequently.

The normalization range may be preferably from zero (0) to unity (1). However, also any other suitable normalization ranges may be used.

According to a further embodiment of the invention the method further comprises, after multiplying each absolute difference value of the maximum difference map with a function value of a non-linear function and before computing the pixel classifying map, modifying the weighing map to a modified weighing map by applying a filtering operation, wherein the modified weighing map is used for computing the pixel classifying map.

The filtering may consist of or may include a convolution and in particular a convolution wherein the range of the (difference) values of the weighing map is expanded. This may further improve the classification validity of cloud/sky images.

According to a further embodiment of the invention computing the pixel classifying map comprises applying the following expression: Pn=Pc*Wp+Pp×(1−Wp). Thereby, Pn is the pixel classifying map, Pc is the second probability map, Pp is the first probability map, and Wp is the weighing map or the modified weighing map. This may provide the advantage that also the last step(s) of the described method can be carried out in a simple but effective manner such that the computational effort can be kept within acceptable limits.

According to a further embodiment of the invention the function value of the non-linear function is taken from a lookup table. This has the effect that not only analytically representable functions but any suitable function depending on the absolute difference value or on the modified absolute difference value or on the further modified absolute difference value can be employed. This may provide the advantage that the described method can be adapted in an application specific manner for different applications, e.g. different applications in different geographical regions.

According to a further embodiment of the invention a codomain for the function value of the non-linear function is between a lower saturation value, wherein the lower saturation value is between zero and unity. The lower saturation value represents a lower limit for the function value. Therefore, the lower saturation value can also be understood as to represent a lower threshold value and/or a lower limit value.

The selected lower saturation value ensures that the values of the weighing map or the modified weighing map are larger than this lower saturation value so that the pixel classifying map Pn has always at least some information from the provided or estimated (current) second probability map Pc (see the above explicitly specified mathematical expression for the pixel classifying map). This also ensures that when clouds move away from a certain area of interest, the previously classified “cloud pixels” will fade away because this area would receive a factor of unity minus the lower saturation value (=1−fn) from the provided or estimated (previous) first probability map Pp.

According to a further embodiment of the invention, with increasing absolute difference value or with increasing modified absolute difference value, (a) in a first region the non-linear function has a constant function value of unity, (b) in a following second region the non-linear function decreases towards the lower saturation value, and (c) in a further following third region the non-linear function has a constant function value of the lower saturation value. Thereby, in the second region the non-linear function may decrease preferably in a linear manner (with increasing absolute difference value or with increasing modified absolute difference value).

The described comparatively smooth transition of the linear function may provide the advantage that the described method can be carried out very stable. In particular, the risk of generating an unwanted and artificial overshooting or oscillations can be significantly reduced.

According to a further aspect of the invention there is provided a data processing unit for classifying pixel within a time series of at least a previously captured first image and a currently captured second image of the sky, wherein each image comprises a plurality of pixels each having a certain intensity value. The data processing unit is adapted for carrying out the method as described above.

According to a further aspect of the invention there is provided a computer program for classifying pixel within a time series of at least a previously captured first image and a currently captured second image of the sky, wherein each image comprises a plurality of pixels each having a certain intensity value. The computer program, when being executed by a data processing unit, is adapted for carrying out the method as set forth in any one of the preceding.

As used herein, reference to a computer program is intended to be equivalent to a reference to a program element and/or to a computer readable medium containing instructions for controlling a computer system to coordinate the performance of the above described method.

The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

The invention described in this document may also be realized in connection with a “CLOUD” network which provides the necessary virtual memory spaces and the necessary virtual computational power.

According to a further aspect of the invention there is provided an electric power system. The provided electric power system comprises (a) a power network; (b) a photovoltaic power plant, which is electrically connected to the power network and which is configured for supplying electric power to the power network; (c) at least one further power plant, which is electrically connected to the power network and which is configured for supplying electric power to the power network and/or at least one electric consumer, which is connected to the power network and which is configured for receiving electric power from the power network; (d) a control device for controlling an electric power flow between the at least one further power plant and the power network and/or between the power network and the at least one electric consumer; and (e) a prediction device for producing a prediction signal being indicative for the intensity of sun radiation being captured by the photovoltaic power plant in the future. The prediction device comprises a data processing unit as described above and the prediction device is communicatively connected to the control device. The control device is configured to control, based on the prediction signal, the electric power flow in the future.

The described electric power system is based on the idea that with a valid and precise prediction of the intensity of sun radiation, which can be captured by the photovoltaic power plant in the (near) future, the power, which can be supplied from the photovoltaic power plant to the power network, can be predicted in a precise and reliable manner. This allows to control the operation of the at least one further power plant and/or of the at least one electric consumer in such a manner that the power flow to and the power flow from the power network are balanced at least approximately. Hence, the stability of the power network and, as a consequence, also the stability of the entire electric power system can be increased.

The prediction device may comprise a camera for capturing a time series of images including the first image and the second image. The time series of images will be forwarded to the data processor for processing the corresponding image data in the manner as described above.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWING

FIG. 1 shows a flow diagram for a method for classifying pixel within a time series of input images.

FIG. 2 shows an exemplary non-linear function for an intensity difference mapping.

FIG. 3 shows two input images I1 and I2.

FIG. 4 shows an estimated perceptual structural difference image for the first input image I1 and second input image I2.

FIG. 5 shows two cloud classification images, the left one obtained with an algorithm according to prior art, the right one obtained with a method according to an embodiment of the invention.

FIG. 6 shows an electric power system with a data processing unit in accordance with an embodiment of the invention.

### DETAILED DESCRIPTION

The illustration in the drawing is schematic. It is noted that in different figures, similar or identical elements or features are provided with the same reference signs or with reference signs, which are different from the corresponding reference signs only within the first digit. In order to avoid unnecessary repetitions elements or features which have already been elucidated with respect to a previously described embodiment are not elucidated again at a later position of the description.

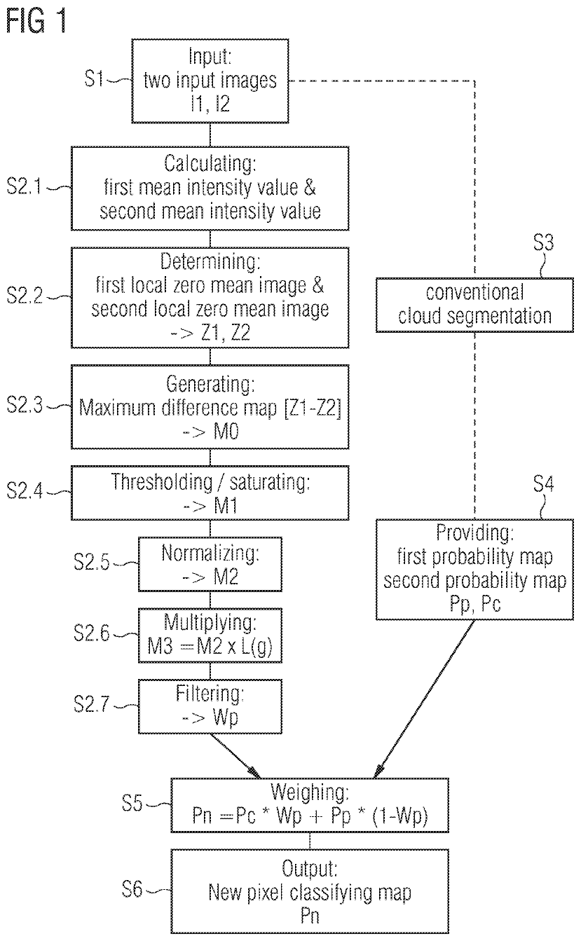

FIG. 1 shows a flow diagram for a method for classifying pixel within a time series of input images. The method starts with a step S1, wherein two images of the sky, a first image I1 and a second image I2, are input in a data processing unit with which the method is carried out. The images I1 and I2 have been captured by a camera viewing the sky. The camera is positioned close to a photovoltaic power station capturing sun light intensity and converting the sun light intensity into electric power.

In a next following step S2.1 there is calculated a first mean intensity value for first pixels of the first image I1 and a second mean intensity value for second pixels of the second image I2. Thereby, an (arithmetic) average intensity value for all pixels within one image I1, I2 is calculated.

In a next step S2.2 there is determined a first local zero mean image Z1 and a second local zero mean image Z2. Thereby, for each first pixel of the first image I1 the before calculated first mean intensity value is subtracted from the individual intensity value of the respective first pixel. Correspondingly, for each second pixel of the second image I2 the before calculated second mean intensity value is subtracted from the individual intensity value of the respective second pixel.

In a next step S2.3 there is generated a maximum difference map |Z1-Z2|, which in this document is denominated as M0.

Thereby, it is calculated for each first pixel of the first image I1 and for a spatially corresponding second pixel of the second image I2, an absolute difference value between a respective first zero mean value of the first local zero mean image Z1 and a respective second zero mean value of the second local zero mean image Z2.

In a next step S2.4 each absolute difference value is modified by applying a threshold operation. Thereby, those absolute difference values, which do not comply with a respective threshold condition, are transformed into modified absolute difference values which differ from the corresponding absolute difference values. Further, those absolute difference values, which do comply with the threshold condition, are transformed into modified absolute difference values which are the same as the corresponding absolute difference values. The result of this threshold operation is a threshold map M1.

According to the exemplary embodiment described here the threshold operation comprises (i) applying an upper threshold value Tu, if the absolute difference value is larger than (or equal to) the upper threshold value Tu and/or (ii) applying a lower threshold value Tl, if the absolute difference value is smaller than (or equal to) the lower threshold value Tl.

In a next step S2.5 a normalization operation is applied to each absolute difference value. According to the exemplary embodiment described here this normalization transforms all values into the range between 0 and 1. The result is a normalized map M2.

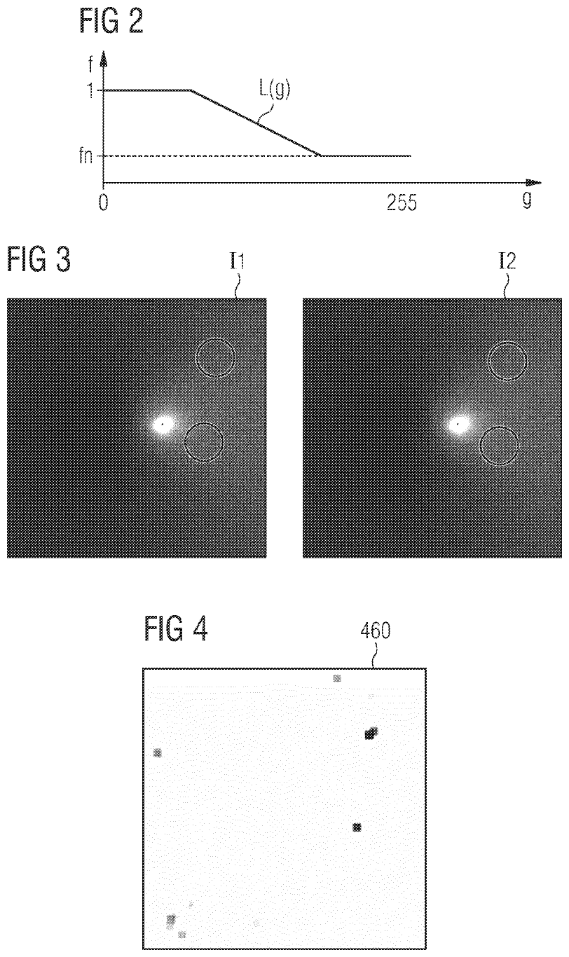

A perception of a processed image depends on the intensity of at least some pixels of the processed image. Therefore, in a next step S2.6 each value of the normalized map M2 is multiplied with a function value of a non-linear function L(g). The non-linear function L(g) being used in the embodiment described here is depicted in FIG. 2, which will be elucidated further below. With this multiplication operation, which yields a multiplied map M3, the perception of the respective image being specified by M3 is improved.

In a next step S2.7 a filtering operation is applied to M3 in order to generate a weighing map Wp. According to the exemplary embodiment described here the filtering operation is a convolution with which the number range of the values of the multiplied map M3 is expanded.

Parallel to at least one of the steps 2.1 to 2.7 there is carried out a step (or procedure) S3 with which there is generated a first probability map Pp and a second probability map Pc. Both probability maps Pp and Pc describe, for each pixel, the probability for representing a portion of a cloud. This is also denominated a cloud segmentation. The first probability map Pp is the cloud segmentation at a first (previous) point in time and the second probability map Pc is the cloud segmentation at a second (current) point in time. It is pointed out that both probability maps Pp and Pc are obtained by means of well-known image classification or processing procedures for a segmentation of cloud/sky images, which procedures also use the captured images I1 and I2 as an input.

With a step S4 the two generated probability maps Pp and Pc are provided as further inputs to the described method.

In a next step S5 the so far generated respectively provided maps Pc, Wp, and Pp are combined by means of a weighing operation. According to the exemplary embodiment described here the formula for weighing is Pn=PC*Wp+Pp×(1−Wp). Thereby, Pn is the new probability map which in this document is denominated a pixel classifying map.

Descriptively speaking, the weighing map Wp is used as a perceptual weighting between the current segmentation map Pc and the previous segmentation map Pp in order to arrive at the new segmentation map Pn (=Pc*Wp+Pp*(1−Wp)). Thereby, this equation is understood as an operation for each pixel value.

FIG. 2 shows an exemplary non-linear function L(g) for an intensity difference mapping from the normalized map M2 to the multiplied map M3. At the abscissa of the shown graph there is depicted the (modified) absolute difference value g. At the ordinate there is depicted the function value f of the non-linear function W(g).

As can be seen from FIG. 2, the non-linear function L(g) comprises a comparatively smooth transition between an upper value 1 and a lower saturation value f(n). The lower saturation value f(n) is between 0 and 1. According to the exemplary embodiment described here the lower saturation value f(n) is smaller than 0,5.

It is mentioned that a non-linear function L(g) with a smooth transition may be preferred. However, the algorithm described here is robust with respect to such fine tuning such that also non-linear functions can be used which exhibit a more sharp transition.

FIG. 3 shows two input images I1 and I2, which are processed with the described method. FIG. 4 shows an estimated perceptual structural difference image 460 illustrating the difference between the first input image I1 and second input image I2 to illustrate the effectiveness of the described method.

The optical conditions when capturing the two input images I1 and I2 are clear-sky. The two images I1 and I2 have been captured with a time difference of 10 seconds. The hardly visible clouds are indicated in each image I1, I2 by two circles. From the left image I1 to the right image I2 the clouds move a few pixels away and nothing else is perceivable.

The Perceptual Structural Difference (PSD) image which has been obtained with the algorithm of the described method is shown in FIG. 4. It is consistent with a human visual perception of the two images I1 and I2. In this Figure referred to as the PSD map, white zones are indicative for image regions which are the same in both images I1 and I2. Black zones are indicative for a clearly different cloud probability and visualize a cloud movement. In this PSD map continuous values are illustrated which are indicative of the probability of difference between the two images I1 and I2. Therefore, any value between the white and black (i.e., gray zone) indicates the strength of difference between I1 and I2. In other words: the darker an image region in the PSD map, the more likely is a difference between I1 and I2 (in this image region).

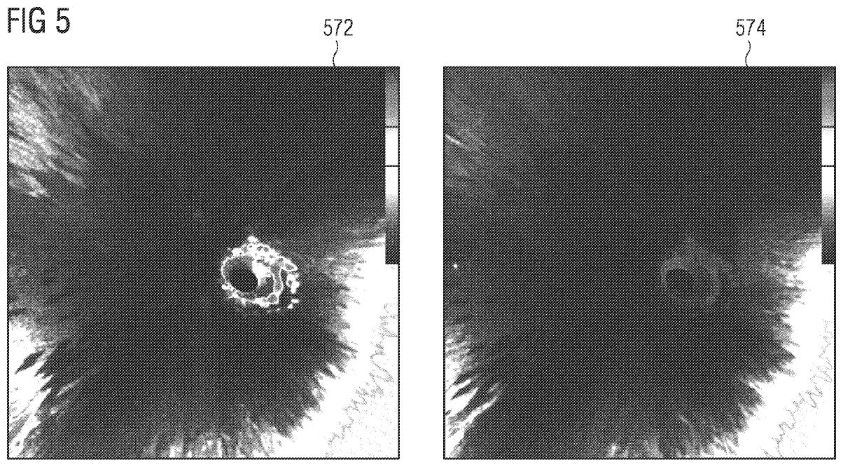

FIG. 5 shows two cloud classification or segmentation images 572 and 574. The cloud classification image 572 shows an image which has been obtained with an algorithm according to the prior art. The cloud classification image 574 has been obtained with a method according to an embodiment of the invention.

The grey scale code bar depicted vertically top right of each image is a scale for the cloud probability. Generally, dark zones indicate a low probability of the respective pixels for representing a cloud and bright zones indicate a high probability of being a cloud. One can clearly see that the image 574 includes some significant corrections of artefacts which are included in the image 572, in particular in the zone or in the region near the sun (approximately in the middle of each image). In the image 574 the clear sky condition is correctly identified without producing a false alarm for a cloud coverage.

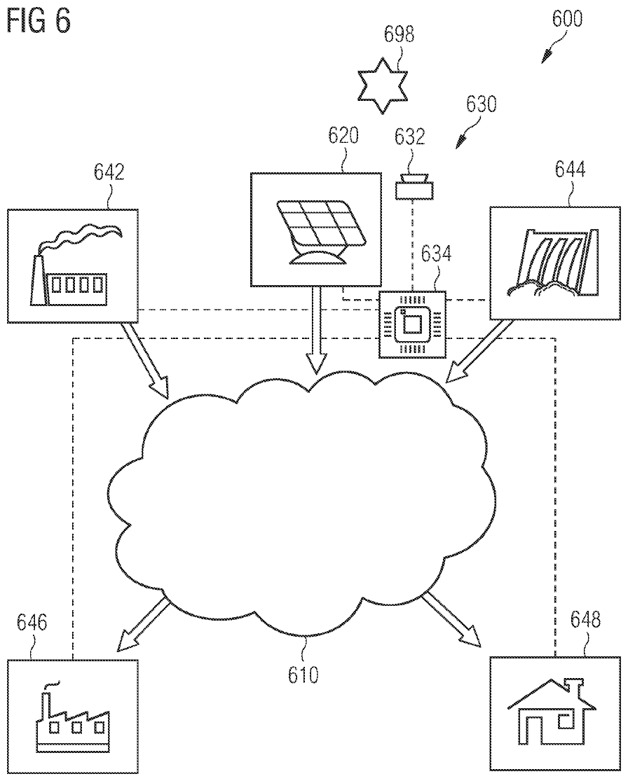

FIG. 6 shows an electric power system 600 in accordance with an embodiment of the invention. The electric power system 600 comprises a power network 610 which receives electric power from three exemplary depicted power plants, a photovoltaic power plant 620, a coal-fired power plant 642, and a hydroelectric power plant 644. It is pointed out that the power plants 642 and 644 are just given as an example and other and/or different numbers of such plants can be used. Further, the electric power system 600 comprises two electric power consumers receiving electric power from the power network 610. In FIG. 6 there are depicted, by way of example, an industrial complex 646 and a household 648. The power flows from the power plants 620, 642, and 644 to the power network 610 as well as the power flows from the power network 610 to the electric consumers 646 and 648 are indicated in FIG. 6 with double arrows.

The photovoltaic power plant 620 is driven by the sun 698 irradiating on non-depicted solar panels of the photovoltaic power plant 620. In order to predict the electric power which can be generated by the photovoltaic power plant 620 in the near future there is provided a prediction device 630. The prediction device 630 comprises a camera 632 for capturing a series of images of the sky over the photovoltaic power plant 620. The captured images, two of which are the input images I1 and I2 as described above, are forwarded to a data processing and control device 634. A data processing section or data processing unit of the data processing and control device 634 is configured for carrying out the method as described above for classifying pixels within the captured images whether they represent cloud or sky. A control section of the data processing and control device 634 is communicatively connected with (at least some of) the power plants 642 and 644 and with (at least some of) the electric consumers 646 and 648. The corresponding wired or wireless data connections are indicated in FIG. 6 with dashed lines.

With (the data processing unit of) the data processing and control device 634 carrying out the described method a cloud occlusion prediction within the near future can be made. This cloud occlusion prediction directly corresponds to a prediction of the power, which can be supplied from the photovoltaic power plant 620 to the power network 610 in the near future. This allows to control, by means of (the control section of) the data processing and control device 634, the operation of the power plants 642, 644 and the electric consumers 646, 648 can be controlled in such a manner that the power flow to and the power flow from the power network 610 are balanced at least approximately. Hence, the stability of the power network 610 and, as a consequence, also the stability of the entire electric power system 600 can be increased.

It is pointed out that in the embodiment described here the data processing unit and the control section are realized by one and the same device, namely the data processing and control device 634. However, it should be clear that the data processing unit and the control section can also be realized by different devices which are communicatively connected in order to forward the prediction signal from the data processing unit to the control section.

In order to descriptively recapitulate embodiments of the invention disclosed in this document one can state: The method described in this document calculates a weighted sum between a current segmentation map and a previous segmentation map. This relies on the assumption that the previous segmentation is not optimal but still satisfactory. Although this is generally true, additional steps are described to further mitigate false alarms of cloud coverage prediction as follows.

(1) If the number of cloud pixels within a designated sun neighborhood is less than a predefined threshold, the near sun area is classified as clear sky and void all cloud pixels.

(2) If the cloud speed is not within certain limits of the (global) average speed, these clouds are removed. This temporally smooths out the cloud segmentation because sudden appearance of clouds would have a very large speed resulting from a most likely wrong segmentation.

3. For those cloud pixels which are not moving towards the sun and which are not within a range of the average direction, they are likely to be noisy pixels and should be eliminated.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

S1 Start: Input two input images
S2.1 Calculating: first mean intensity value & second mean intensity value
S2.2 Determining: first local zero mean image Z1 & second local zero mean image Z2
S2.3 Generating: Maximum difference map M0=|Z1-Z2|
S2.4 Thresholding/saturating:->M1
S2.5 Normalizing:->M2
S2.6 Multiplying: M3=M2×L(g)
S2.7 Filtering:->Wp
S3 conventional cloud segmentation
S4 Providing: first probability map Pp & second probability map Pc
S5 Weighing: Pn=Pc*Wp+Pp*(1−Wp)
S6 Output: New pixel classifying map Pn
I1, I2 first/second input image
Z1, Z2 second/second local zero mean image
M0 maximum difference map
M1 threshold map
M2 normalized map
M3 multiplied map
Wp (modified) weighing map
Pp first (previous) probability map
Pc second (current) probability map
Pn (new) pixel classifying map
g absolute difference value
f function value
L(g) non-linear function
f(n) lower saturation value
460 estimated perceptual structural difference image for first output image I1 and second output image I2
572 cloud classification image obtained with a prior art algorithm
574 cloud classification image obtained with a method according to an embodiment of the invention
600 electric power system
610 power network
620 photovoltaic power plant
630 prediction device
632 camera
634 data processing and control device
642 coal-fired power plant/gas-fired power plant
644 hydroelectric power plant
646 industrial complex/factory
648 household(s)/domestic home(s)
698 sun

1-13. (canceled)

14. A method for classifying pixels within a time series of a previously captured first image and a currently captured second image of the sky, each image having a plurality of pixels each with a given intensity value, the method comprising:
providing, for the first image, a first probability map that includes, for each pixel, a first probability value that the pixel represents a cloud in the sky and providing, for the second image, a second probability map that includes, for each pixel, a second probability value that the pixel represents a cloud in the sky;
calculating a first mean intensity value for first pixels of the first image and a second mean intensity value for second pixels of the second image; determining a first local zero mean image by subtracting, for each first pixel, the first mean intensity value from the intensity value of the respective first pixel and a second local zero mean image by subtracting, for each second pixel, the second mean intensity value from the intensity value of the respective second pixel;
generating a maximum difference map by calculating, for each first pixel and for a spatially corresponding second pixel, an absolute difference value between a respective first zero mean value of the first local zero mean image and a respective second zero mean value of the second local zero mean image;
producing a weighting map by multiplying each absolute difference value of the maximum difference map with a function value of a non-linear function specifying the function value as a non-linear function of the absolute difference value; and
computing a pixel classifying map based on the first probability map, the second probability map, and the weighting map.

15. The method according to claim 14, wherein:
the first image is a first color image having at least three first spectral intensity values for each first pixel; and
the second image is a second color image having at least three second spectral intensity values for each second pixel;
for determining the two local zero mean images:
the first mean intensity value is given by the mean intensity of all first spectral intensity values;
the second mean intensity value is given by the mean intensity of all second spectral intensity values;
the first local zero mean image comprises at least three first spectral zero mean images each being determined by subtracting, for each first pixel, the first mean intensity value from the first spectral intensity value of the respective first pixel; and
the second local zero mean image comprises at least three second spectral zero mean images each being determined by subtracting, for each second pixel, the second mean intensity value from the second spectral intensity value of the respective second pixel; for generating the maximum difference map
the absolute difference value is a maximum absolute difference value which is given by the biggest absolute difference of at least three spectral absolute difference values, wherein each one of the at least three spectral absolute difference values is calculated by, for each first pixel and for a spatially corresponding second pixel, the absolute difference value between one of the three first spectral intensity values and a spectrally corresponding one of the three second spectral intensity values.

16. The method according to claim 14, further comprising, after generating the maximum difference map and before producing the weighting map, modifying each absolute difference value by applying a threshold operation.

17. The method according to claim 16, wherein applying the threshold operation comprises:
applying an upper threshold value, if the absolute difference value is geater than the upper threshold value; and/or
applying a lower threshold value, if the absolute difference value is smaller than the lower threshold value.

18. The method according to claim 16, which comprises,
after modifying each absolute difference value by applying the threshold operation and before producing the weighting map,
further modifying each absolute difference value by applying a normalization operation.

19. The method according to claim 14, further comprising,
after multiplying each absolute difference value of the maximum difference map with a function value of a non linear function, and before computing the pixel classifying map;
modifying the weighting map to a modified weighting map by applying a filtering operation, and using the modified weighting map for computing the pixel classifying map.

20. The method according to claim 19, wherein the step of computing the pixel classifying map comprises applying the following expression:
Pn=PC*Wp+Pp×(1−Wp)
where:
Pn is the pixel classifying map;
Pc is the second probability map;
Pp is the first probability map; and
Wp is the modified weighting map.

21. The method according to claim 14, wherein the step of computing the pixel classifying map comprises applying the following expression:
Pn=PC*Wp+Pp×(1−Wp)
where:
Pn is the pixel classifying map;
Pc is the second probability map;
Pp is the first probability map; and
Wp is the weighting map.

22. The method according to claim 14, which comprises obtaining the function value of the non-linear function from a lookup table.

23. The method according to claim 14, wherein a codomain for the function value of the non-linear function lies between a lower saturation value, wherein the lower saturation value is between zero and unity.

24. The method according to claim 14, wherein, with increasing absolute difference value or with increasing modified absolute difference value,
in a first region the non-linear function has a constant function value of unity;
in a following second region the non-linear function decreases towards the lower saturation value; and
in a further following third region the non-linear function has a constant function value of the lower saturation value.

25. A data processing unit for classifying pixels within a time series of a previously captured first image and a currently captured second image of the sky, wherein each image comprises a plurality of pixels each having a given intensity value, and wherein the data processing unit is configured for carrying out the method according to claim 14.

26. A non-transitory computer program for classifying pixels within a time series of at least one previously captured first image and a currently captured second image of the sky, wherein each image comprises a plurality of pixels each having a given intensity value, the computer program, when being executed by a data processing unit, being configured for carrying out the method according to claim 14.

27. An electric power system, comprising:
a power network;
a photovoltaic power plant for supplying electric power to said power network;
at least one further power plant for supplying electric power to said power network and/or at least one electric consumer for receiving electric power from said power network;
a control device for controlling an electric power flow between said at least one further power plant and said power network and/or between said power network and said at least one electric consumer; and
a prediction device for producing a prediction signal being indicative of an intensity of a sun radiation to be captured by said photovoltaic power plant in the future; wherein
said prediction device having a data processing unit according to claim 25;
said prediction device is communicatively connected to said control device; and
said control device being configured to control, based on the prediction signal, the electric power flow in the future.
